(19) United States
(12) Patent Application Publication
(10) Pub. No.: US 2017/0161826 A1
(43) Pub. Date: Jun. 8, 2017

(54) REPORT GENERATING SYSTEM FOR PROVIDING REAL TIME AND/OR PROACTIVE DEBT INSTRUMENT APPROVAL, AVAILABILITY, ANALYSIS AND RECOMMENDATION TO A CONSUMER

(71) Applicant: American Financial Resources, Inc., Parsippany, NJ (US)

(72) Inventors: William S. Packer, Parsippany, NJ (US); Scott R. Dubnoff, Parsippany, NJ (US); Robert G. Pieklo, Parsippany, NJ (US)

(73) Assignee: American Financial Resources, Inc.

(21) Appl. No.: 15/084,289

(22) Filed: Mar. 29, 2016

Related U.S. Application Data
(60) Provisional application No. 62/264,072, filed on Dec. 7, 2015.

(51) Int. Cl. G06Q 40/02

(52) U.S. Cl. CPC G06Q 40/025

(57) ABSTRACT

A report, loan estimate and approved debt instrument package generating system for determining a preferred, available debt instrument package approved for individual consumers is disclosed. A typical scenario is a consumer having obtained a loan offer for a mortgage loan on a standardized loan estimate form and utilizing the system disclosed herein, receiving back an analysis of that loan offer with comparison(s) to other available and approved loan offers and/or actually receiving back an alternative lender's loan estimate form and/or actually receiving back alternative loan packages for closing. The system is further configured to monitor, suggest improvements to and provide the ability to change a consumer's fiscal situation in real time.

### FIELD OF THE INVENTION

A report, loan estimate and approved debt instrument package generating system for determining a preferred, available debt instrument package approved for individual consumers is disclosed. A typical scenario is a consumer having obtained a loan offer for a mortgage loan on a standardized loan estimate form and utilizing the system disclosed herein, receiving back an analysis of that loan offer with comparison(s) to other available and approved loan offers and/or actually receiving back an alternative lender's loan estimate form and/or actually receiving back alternative loan packages for closing. The system is further configured to monitor, suggest improvements to and provide the ability to change a consumer's fiscal situation in real time.

The present application claims the benefit of the prior filed U.S. Provisional Application No. 62264072, filed by the present inventors on December 7, 2015, which is incorporated herein by reference.

### BACKGROUND

Typically, loan consumers must shop around and get approved for all types of loans. In order to get approved, the potential lender obtains information from the applicant, usually recent pay stubs, tax returns and the like and verifies the same by running a credit check and other background checks. This verifies the information provided is accurate and complete and upon which a credit decision can be made. Credit inquiries can affect credit scores which affect lending decisions. There is a difference between a ‘hard inquiry’ and a ‘soft inquiry.’ A hard inquiry occurs when a potential loan offeror checks an applicant's credit score upon which to base a lending decision, i.e., there is a pending actual credit application for which a consumer wants to be approved. A soft inquiry occurs when the inquiry is simply informational, i.e., when a consumer wants to know their own credit score, i.e., there is no actual pending credit application. In order to shop around for the best loan offer, a consumer must actually apply for multiple loans, only intending to choose the most favorable approved loan. However, each lending institution must check an applicant's credit score in connection with each particular loan inquiry thus generating numerous hard inquiries on the applicant's credit report that will have a negative effect on applicant's credit score. This negative correlation means that rates offered to applicants will tend to go up the more an applicant shops around for a loan. Lending institutions need to verify applicant provided information and will generally not accept an applicant provided printout of a credit score.

Moreover, it is a lot of time and effort for a consumer to continually monitor their fiscal situation and apply for new loans to supplant existing ones that might better their monthly cash flow or pay loans at a quicker rate. This truth typically leads to consumers simply not bothering and paying more than they otherwise should or need to. In fact, consumer mortgage debt and consumer credit card debt is economically stifling because it depletes ready cash or extra cash that might otherwise be used to make non-necessary purchases and thus stimulate the economy. If there were a way for consumers to make better choices about the debt structure they have at any given moment and to continually choose to pay less at the same rate or more quickly for the same or lesser amount, this would free up spending cash rather than having those ‘extra’ payments and higher rates benefit only the original lender who enjoys collecting simply because the process is too mystifying or too cumbersome.

Consumer debt instruments, such as residential mortgage loans, are offered to consumers in a wide range of structures. They will vary in term (length of repayment period); in rate (percentage of extra repayment on top of the principal that the lender charges for use of the money); rate type (fixed or adjustable); amortization (the way the rate gets calculated); and upfront costs (additional fees such as application fees, administrative fees and the like) that the lender charges. Additionally, there is a balloon payment loan wherein the initial repayment period is low with a final ‘balloon’ payment required at the loan period end. Comparing various debt instruments can be extremely daunting and time-consuming for the average consumer, and in many cases, will be comparing apples to oranges.

The U.S. Consumer Financial Protection Bureau (“CFPB”) recently implemented new rules requiring mortgage loan lenders to provide mortgage loan estimates/offers to applicants on a Standardized Loan Estimate Form wherein the various factors associated with the various loan types and all fees charged are disclosed (the “Standardized Loan Estimate”). Thus, whether the loan offer is for a fixed rate mortgage (FRM), an adjustable rate mortgage (ARM) or an interest only loan (a type of loan product where for a period of time, the loan payment requires only interest where after the expiration of that initial period, the remaining amortization period converts to either a FRM or ARM), and whether the lender charges an application fee, points for various rate reductions, and other charges, the Standardized Loan Estimate provides identical standardized loan information to the applicant. The Standardized Loan Estimate is intended by the CFPB to allow consumers to compare apples to apples.

Rates can be affected by upfront payments made to reduce the rate. These upfront payments are typically called points (or, in the case of a car lease loan, may be called a Cap Cost Reduction, although this is an actual principal value reduction, whereas ‘points’ merely reduce the interest rate), which are a percentage of the loan principal. For example, a consumer could pay two points, or two percent of the loan principal upfront as an extra fee in order to reduce the rate by one percent. This may be desirable if the consumer intends to keep the loan for a long period (i.e., not sell the property prior to the end of the natural loan payoff and pay off the loan balance early), but may be undesirable in the reverse circumstance.

Loan products are often marketed to consumers by their annual percentage rate (APR). This is the internal rate of return of the resulting cash flows from a given loan. However, the APR is based on the full scheduled life of the loan taking into account the transaction costs (such as points, application fees and other initial loan costs). If the loan is going to be paid off early, such as in the case of selling the property financed (a common occurrence, even when unplanned initially), the APR may actually be ultimately much higher than advertised because the upfront costs are then spread over a much shorter time period.

Presently, consumers have many choices of debt instruments from which to choose when financing a large purchase. While each individual feature (rate, term, ARM, FRM, interest only, points, etc.) may have individual appeal in a given circumstance, it is difficult to compare which total package of features that comprise each debt instrument is overall the best for a consumer in a given circumstance. Moreover, comparing loans against one another often requires a consumer to actually apply for the loan to determine what it is that they may qualify for and get approved, i.e., advertised rates and terms may not actually be the approved rates and terms. As noted above, doing so can negatively impact an applicant's credit actually penalizing a consumer for being proactive in searching out alternative loan products to compare.

It is an object of the current disclosure to teach a system and method of providing a consumer with the ability to, not only compare a debt instrument that they are considering to other available alternative debt instruments without affecting the consumer's credit score and without having to actually apply for other available debt instruments, but also to actually provide the consumer with alternative ‘locked in’ standardized loan estimates or other debt instrument offerings. It is a further object of the current disclosure to teach a system and method of affirmatively providing a consumer with alternative approved debt instrument(s) equal or better from an overall cost perspective as compared to a specific debt instrument(s) provided by the consumer that they currently have. It is a further object of the current disclosure to teach a system and method of affirmatively monitoring a consumer's debt obligation and overall fiscal situation to provide the consumer with alternative debt instrument(s) likely to improve the consumer's ability to repay that are then available to that consumer in real time. It is a further object of the current disclosure to teach a system and method whereby consumers can opt in and provide permissions for continuous up-to-date debt instrument application materials such that the system and method can provide the consumer with up-to-date pre-approved ready to close debt instrument alternative packages that can improve the consumer's fiscal situation at pre-determined intervals. It is a further object of the current disclosure to provide a consumer with reports, in real time, at any given time as requested by the consumer and/or as the system determines that a better debt instrument package should be considered by the consumer, that detail to the consumer what debt instrument(s) the consumer currently has and what debt instrument(s) are actually available to the consumer at that moment, and from what lenders, that would improve the fiscal situation of the consumer under specified conditions. This type of knowledge and these reports are both empowering and heretofore unavailable, even to the most proactive of consumers because the type of information contained in these reports would take too long to assemble under existing and conventional methods, i.e., by the time it was generated, it would no longer be ‘fresh’ and, in some cases, some loan quotes, no longer valid by the time subsequent ones were generated. It is a further object of the current disclosure to provide a consumer with an ability to actually accept the new debt instruments to replace existing debt instruments in order to immediately improve the fiscal situation of the consumer.

Attempts have been made to automate consumer debt instrument choice. For example, U.S. Pat. No. 8,478,670 titled, METHOD AND SYSTEM FOR DETERMINING WHICH MORTGAGE IS BEST FOR A CONSUMER discloses, “a method and system for selecting a preferred debt instrument (e.g., mortgage) for an individual consumer, where the option adjusted spreads (OAS) and risk measures of a plurality of debt instruments are determined and ranked using standard bond valuation methodology. A typical scenario involves a consumer inputting a plurality of mortgages and associated features (e.g., term of loan or type of interest rate) and receiving the option adjusted spread and risk measure for each mortgage, from which the consumer may select the appropriate mortgage having the lowest option adjusted spread within his or her risk tolerance. These steps can be implemented by a computer which includes a central processing unit (CPU) and a computer code operatively associated with the CPU. The relative option adjusted spreads and risk measures of various debt instruments can be displayed on a visual display or used to automatically commence the financing of a mortgage.”

In another example, U.S. Patent Publication No. US 2008/0109378 titled, FINANCIAL PRODUCT FREQUENT IDENTIFICATION AND COMPARISON SERVICE, discloses, “systems and methods for identifying and comparing financial products on a regular basis are disclosed. Client information is collected, validated, and stored in a data warehouse and kept up to date. Client information is periodically transmitted to decision making components and information about financial products for which the client is eligible is received. The system comprehensively compares the received financial products and determines which of them, if any, is best for the client. The system transmits the chosen financial products to the client. If the client decides to obtain one of the financial products, the system facilitates the process of obtaining the financial product.”

In another example, U.S. Pat. No. 8,527,402 titled, MORTGAGE LOAN DATA PROCESSING SYSTEM AND METHOD FOR A LOAN BROKER, discloses, “an exemplary embodiment includes a data processing system and method for managing the origination of a mortgage loan by a loan originator in coordination with a loan broker for a loan customer. The loan originator is not the loan broker. The loan originator provides services necessary for the origination of the mortgage loan and not duplicative of services provided by the loan broker.”

In another example, U.S. Patent Publication No. US 2011/0055110 titled, ONLINE

CALCULATORS FOR OFFERING FINANCIAL PRODUCTS AND SERVICES, discloses, “a system and method for receiving a user's financial information, calculating average corresponding financial information for a group of comparative individuals, displaying a customized virtual financial calculator, receiving data input by the user in the displayed customized virtual calculator, and offering a financial product or service calculated to be most appropriate to the user's needs based on the user and comparative data received.”

The current efforts of the CFPB in requiring mortgage loan providers to render a

Standardized Loan Estimate is a further effort to provide consumers with knowledge needed to make effective debt instrument choices and to insure that lenders cannot hide fees or add in fees at a later time. The Standardized Loan Estimate locks in all fees and charges that a lender can charge for a given loan estimate. However, it is not a loan application and is not a hard inquiry on a consumer's credit. It does however, signify, a consumer who is serious about obtaining credit to have undertaken that level of effort to obtain one. But even these serious consumers have time constraints and will get frustrated attempting to obtain two, three, four or more Standardized Loan Estimates from various different lenders. And, if that effort is spread out over days or weeks, the various reports may actually have different expirations and may not, in fact, be truly comparing apples to apples.

None of the foregoing references, alone or in combination, teach the salient and proprietary features of the present disclosure. While there are many ‘rate comparison tools’ in existence, the disclosure herein teaches much more than a mere rate comparison tool. There remains a need for a system and method enabling consumers to take charge of their own financial situation by enabling them essentially to become ‘industry insiders’ with access to knowledge of and availability of the plethora of debt instruments, all in real time and at the same time, without requiring a credit score destroying hard inquiry, that would be applicable and advisable and approved for them in given situations, and moreover, to generate easy to understand reports regarding choices and an ability to request and/or accept alternative debt instrument offerings.

### SUMMARY

The present disclosure teaches embodiments that solve the foregoing shortcomings. In one embodiment, the instant disclosure teaches a system and method that allows the input of a specific loan estimate disclosure that has been offered to a consumer and outputting to that consumer a report noting debt instrument alternatives available to them in real time and without negatively impacting the consumer's credit score. In another embodiment, the instant disclosure teaches a system and method that affirmatively provides a consumer with alternative approved debt instrument(s) that is equal or better from an overall cost perspective as compared to a specific debt instrument(s) provided by the consumer that they may already have, again, in real time and without negatively impacting credit scores. In another embodiment, the instant disclosure teaches a system and method of affirmatively monitoring a consumer's debt obligation and overall fiscal situation and providing the consumer with alternative debt instrument(s) likely to improve the consumer's ability to repay, again, in real time and without negatively impacting credit scores. In another embodiment, the instant disclosure teaches a system and method that allows a consumer who has obtained a Standardized Loan Estimate to upload it to the system and be given in return, a report detailing alternative available Standardized Loan Estimates from various lenders that may have more favorable rates and/or fees and providing the ability to request such Standardized Loan Estimates from those lenders at that same moment without having to establish an account or speak with a representative from that lender that would otherwise slow the whole process. In another embodiment, the instant disclosure teaches a system and method that generates reports to the consumer in real time containing any or all of the foregoing information empowering a consumer to know at any instant in time, what debt instrument(s) the consumer has and what debt instrument(s) are approved and available to them such that the consumer can make educated and informed choices and be prompted make choices for accepting to restructure debt instruments when that report demonstrates a predetermined level of savings is available. In one embodiment, the foregoing may be provided through a portal advertised by a third party website.

In one embodiment, the system and method disclosed herein allows users to upload Standardized Loan Estimates received from a lending institution and receive a report comparing the overall loan costs of the user submitted Standardized Loan Estimate to specific other Standardized Loan Estimates of other lenders. In one embodiment, the system and method disclosed herein allows users to simply request alternative Standardized Loan Estimates from other lenders on a predefined list of lenders who have chosen to opt in to the system. In one embodiment, the foregoing is achieved through a web based form application generating the report or receiving and reacting to the request online. In one embodiment, the foregoing is achieved through a third party website wherein said third party website provides a portal through to the web based form application for consumers to upload a document, receive back a report and/or request specific lender's Standardized Loan Estimates and for those alternative specific lender's to respond to a consumer's request by providing a requested Standardized Loan Estimate and the system configured to monitor through put activity of consumers and lenders through the web portal. In one embodiment, the forgoing is enabled by the system being configured to automatically parse the necessary variables from the Standardized Loan Estimate and comparing all the parsed variables from the Standardized Loan Estimate to the same variables of alternative Standardized Loan Estimates.

### BRIEF DESCRIPTION OF THE DRAWINGS

FIG. 1 depicts the prior art methodology of a consumer desiring a loan, gathering the required documentation and applying, then receiving a credit decision that either allows the consumer to consider the merits of closing on that particular loan or upon being denied, starting the whole process anew. This method, whether or not an approval is issued, will result in a hard inquiry on the consumer's credit report.

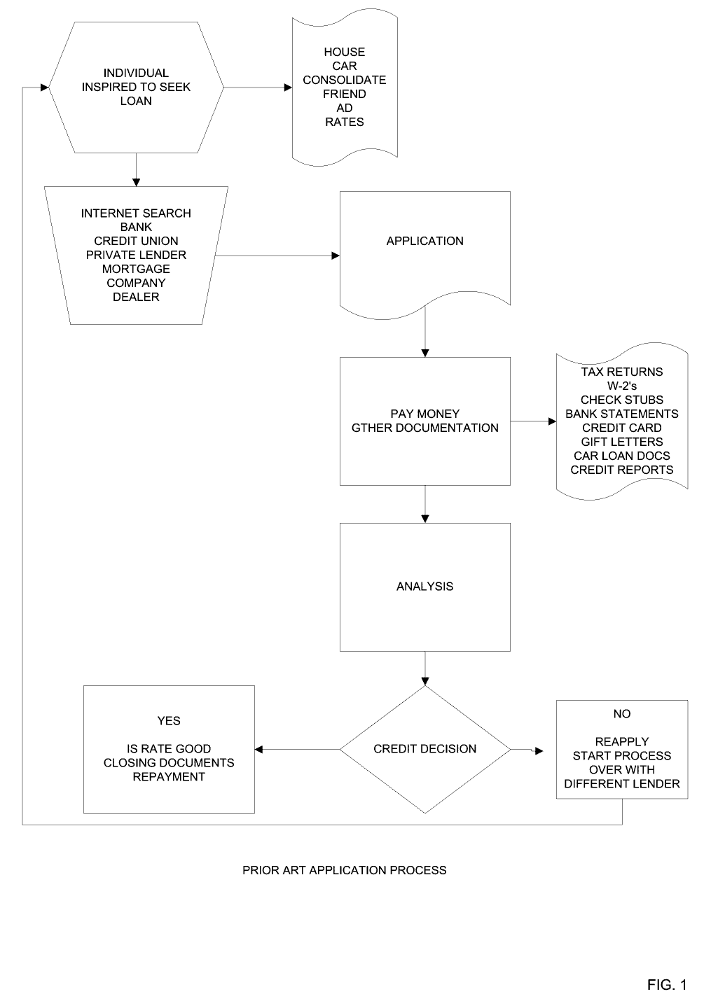

FIG. 2 depicts an embodiment as disclosed by the instant disclosure whereby a consumer gathers all loan required documentation and applies to be a part of the system and method that also requires permissions to continually receive up to date required documents and instead of applying to lenders, the consumer will be provided with loan options that are approved without any hard inquiry and only upon knowing of various approved debt instruments will the consumer choose one for a closing package to be generated.

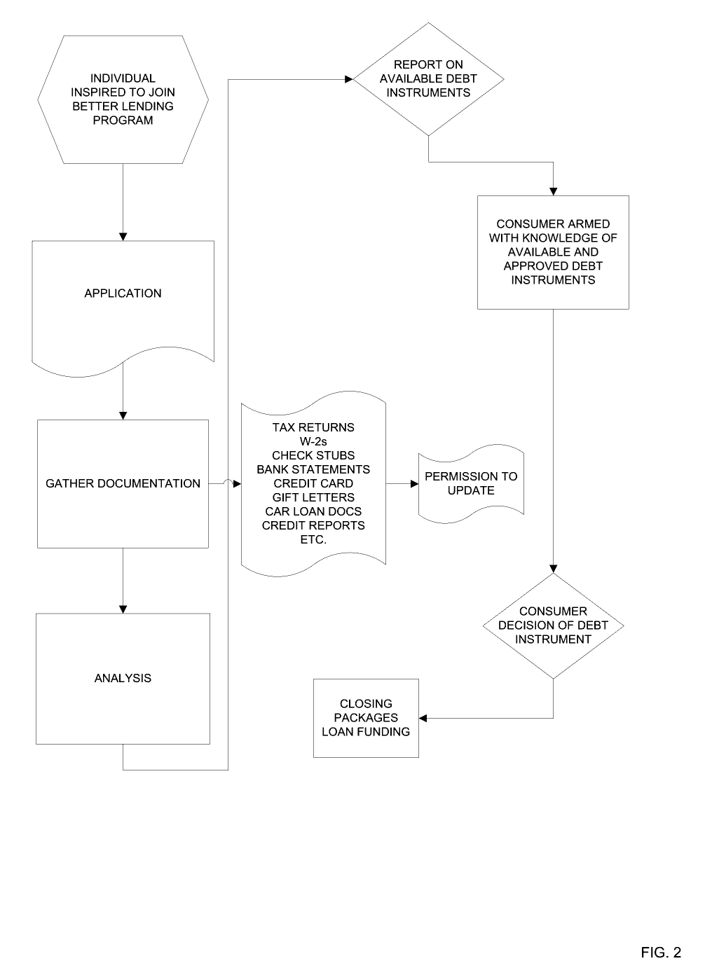

FIG. 3 depicts a prior art method of obtaining a Standardized Loan Estimate from a lender and either applying for a loan with that lender or seeking alternative choices from other lenders.

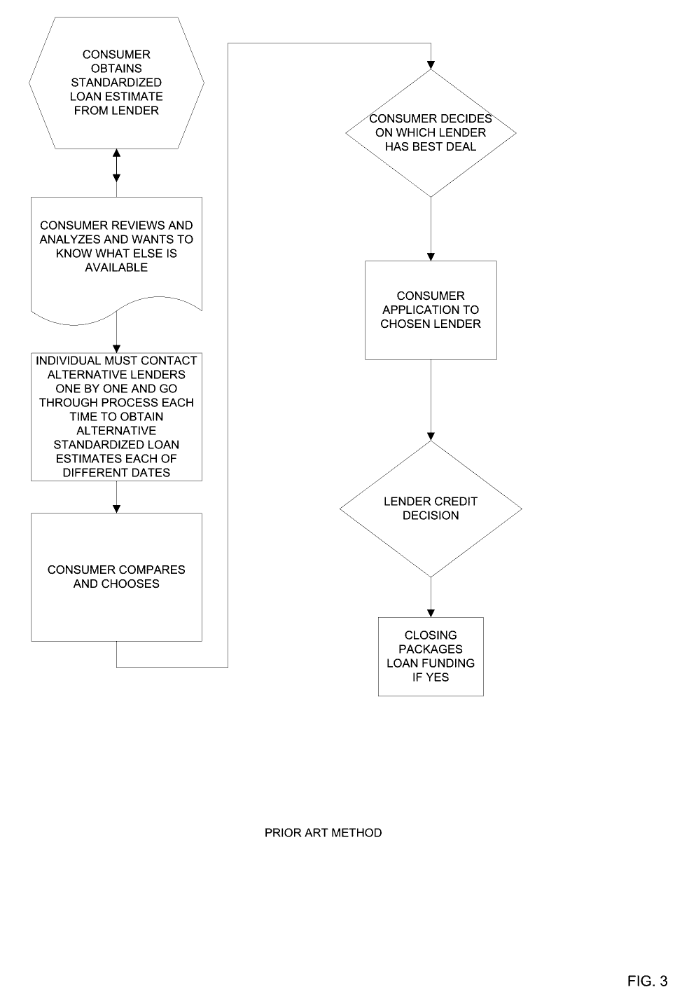

FIG. 4 depicts a new method as disclosed in one embodiment of the instant disclosure of obtaining alternative Standardized Loan Estimates from alternative lenders after having obtained an initial Standardized Loan Estimate from a first lender.

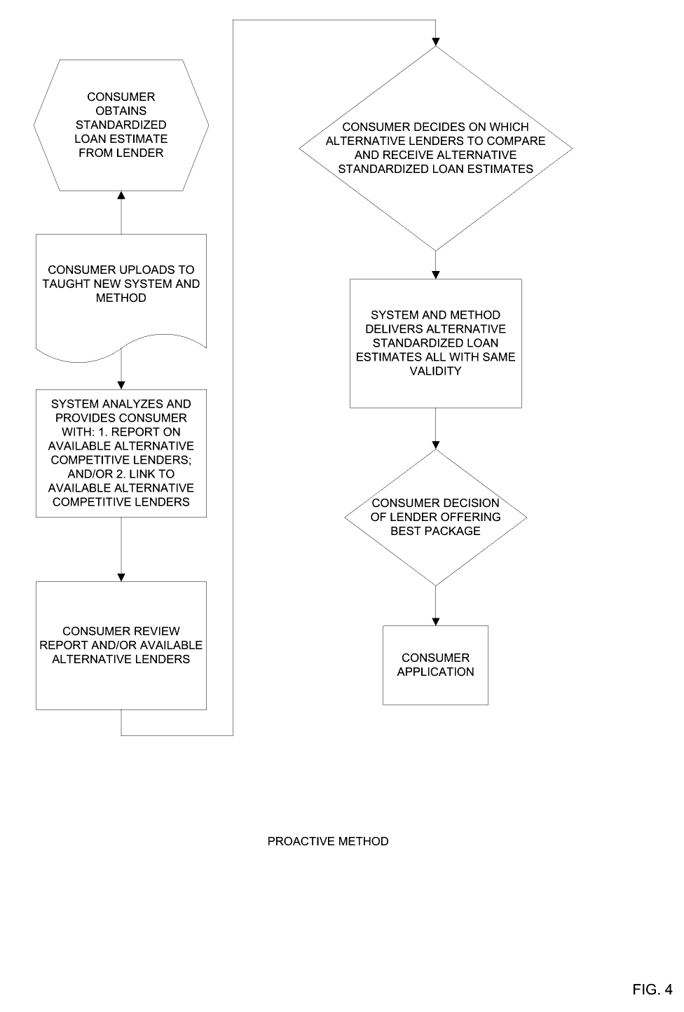

FIG. 5 depicts one embodiment of the instant disclosure describing potential interactions of a consumer/user and various components of the proposed system and method, in an order that they can occur and file flow paths.

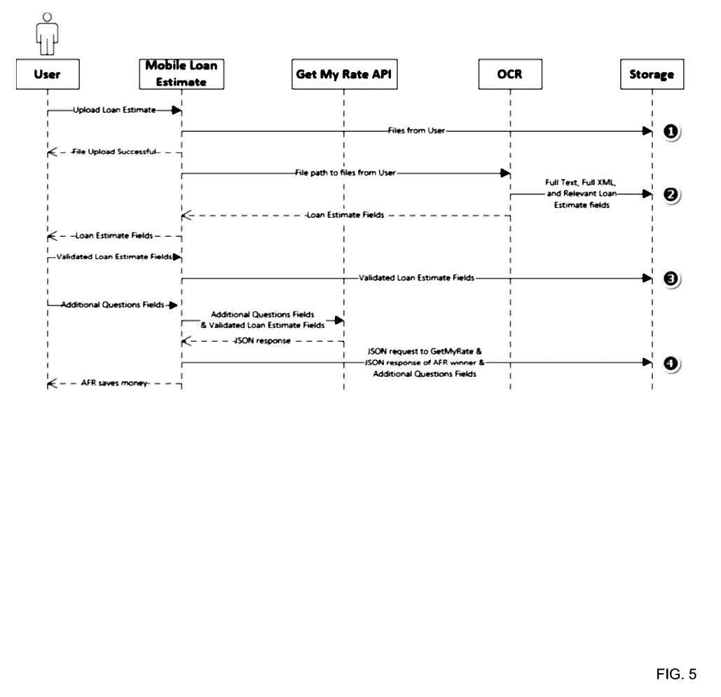

FIG. 6 depicts one embodiment of the instant disclosure describing the interactions between the software modules of the system.

FIG. 7 depicts one embodiment of the instant disclosure of potential file flow paths for uploading files and running those uploaded files through OCR recognition software modules.

FIG. 8 depicts one embodiment of the instant disclosure wherein a number of tables are created to store results of parsed input, namely: LoanEstimate—A table storing the data taken from the loan estimate; LoanEstimateFile—A table storing the file paths and original file names which were uploaded; LoanComparisonValidatedDetail—A table storing the validated data; and LoanEstimateComparison—A table which logically relates each of the tables above to each other.

FIG. 9 depicts one embodiment of the instant disclosure of typical screenshots of a branded mobile device application with features enabled to obtain loan offers. The branding is not part of nor necessary to this disclosure but merely included as how it might appear as a real world example.

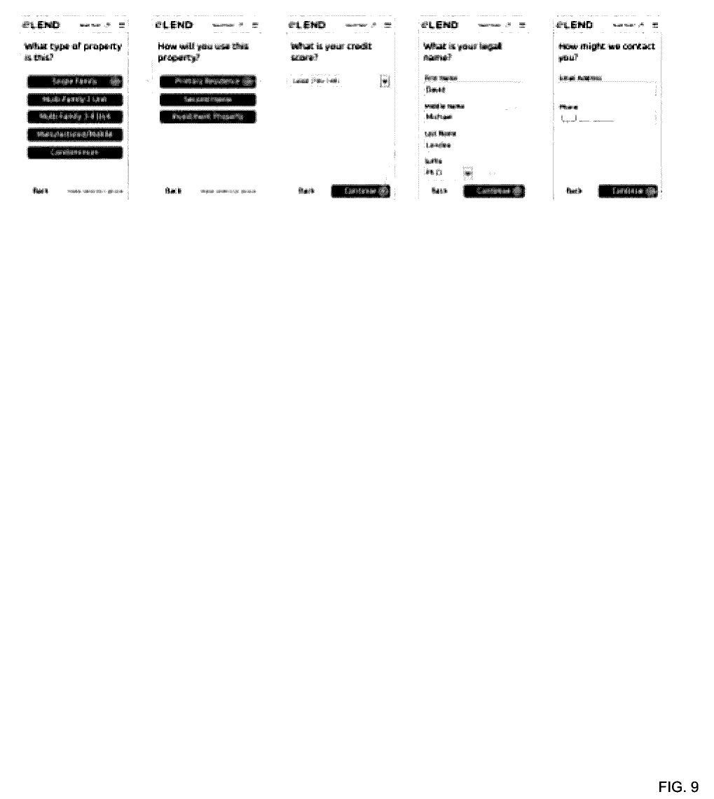

FIG. 10 depicts one embodiment of the instant disclosure wherein results of varying comparisons of loans are returned.

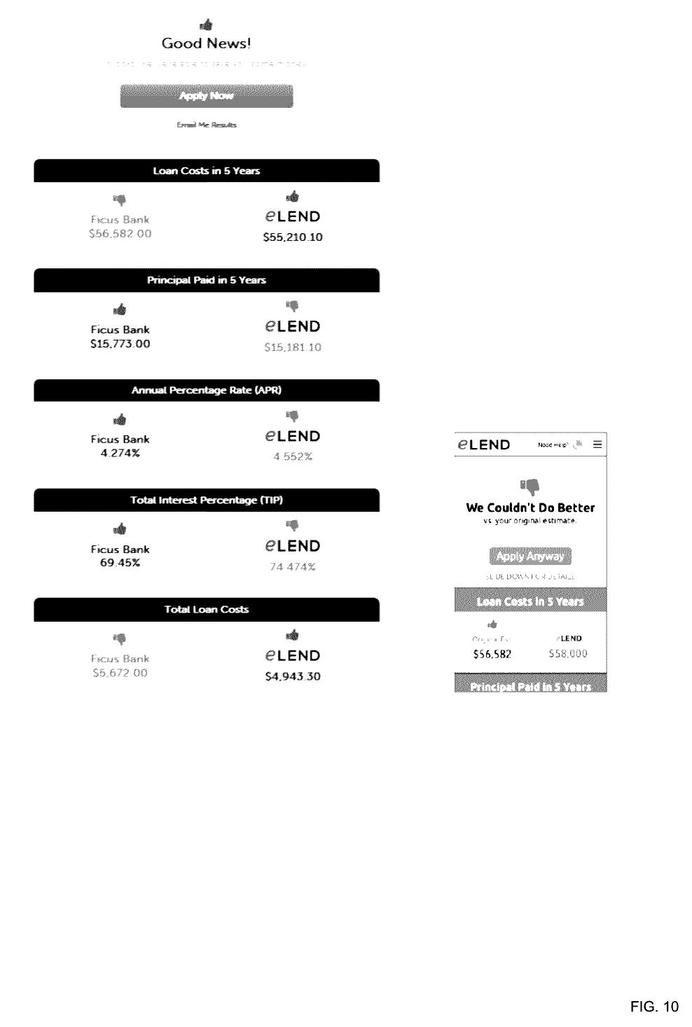

FIG. 11 depicts one embodiment of potential work flow of teachings of the instant disclosure enabling questions to be posed to the consumer at various points along the work flow process.

FIG. 12 depicts one embodiment of the instant disclosure demonstrating potential file flow paths of handling various file uploads to the consumer obtaining results.

FIG. 13 depicts one embodiment of the instant disclosure demonstrating potential file flow paths of comparing loan offers, displaying results reports, saving or deleting files and offering application options.

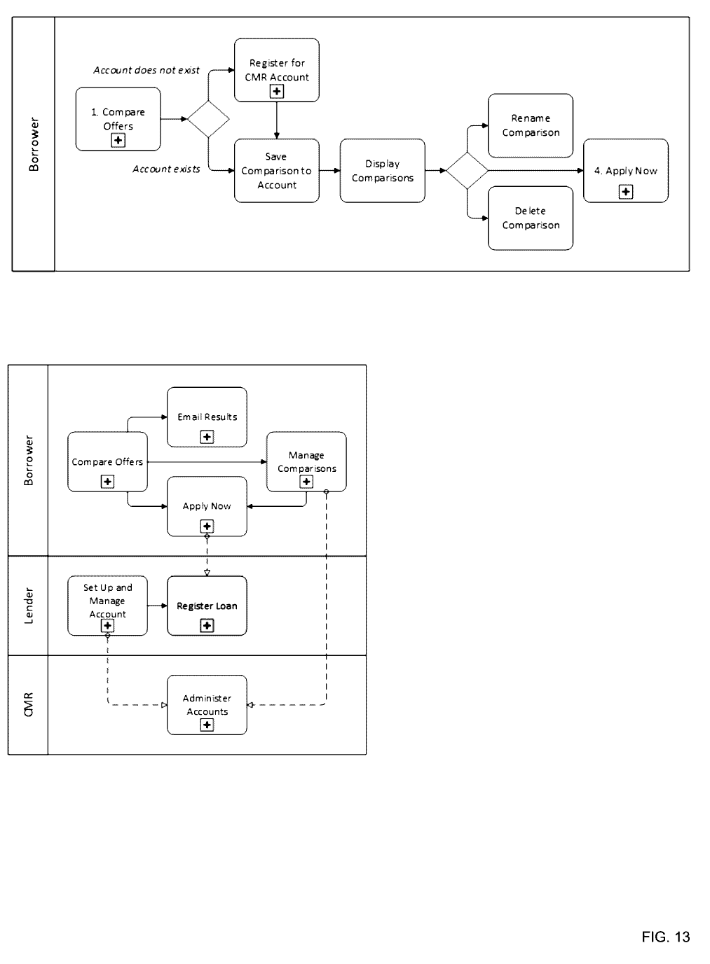

FIG. 14 is a sample page one of a Standardized Loan Estimate example.

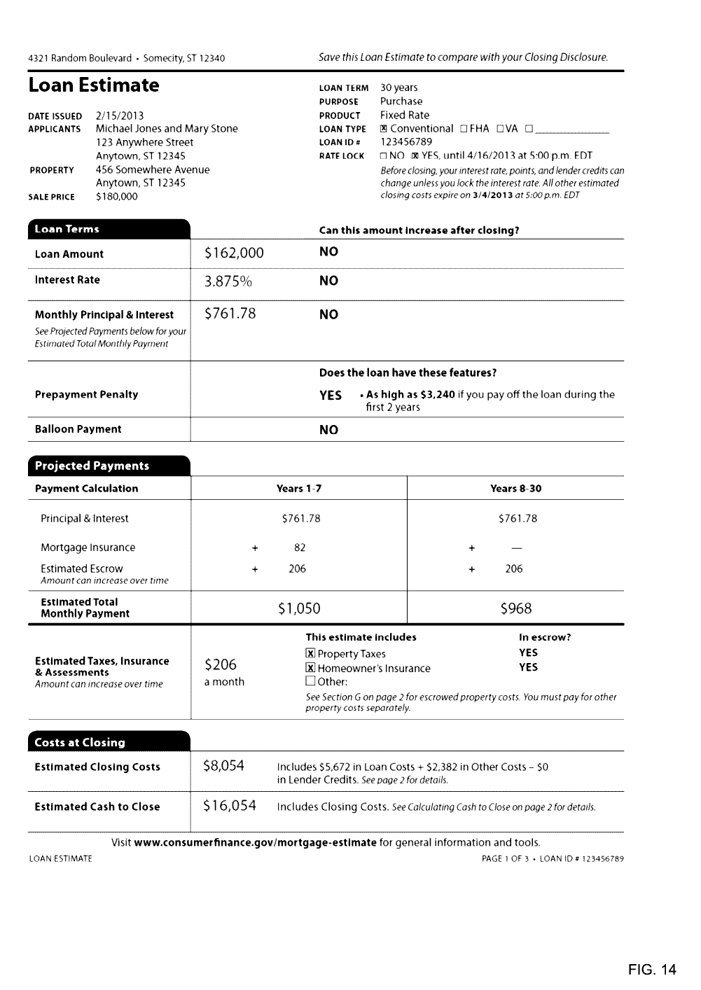

FIG. 15 is a sample page two of a Standardized Loan Estimate example.

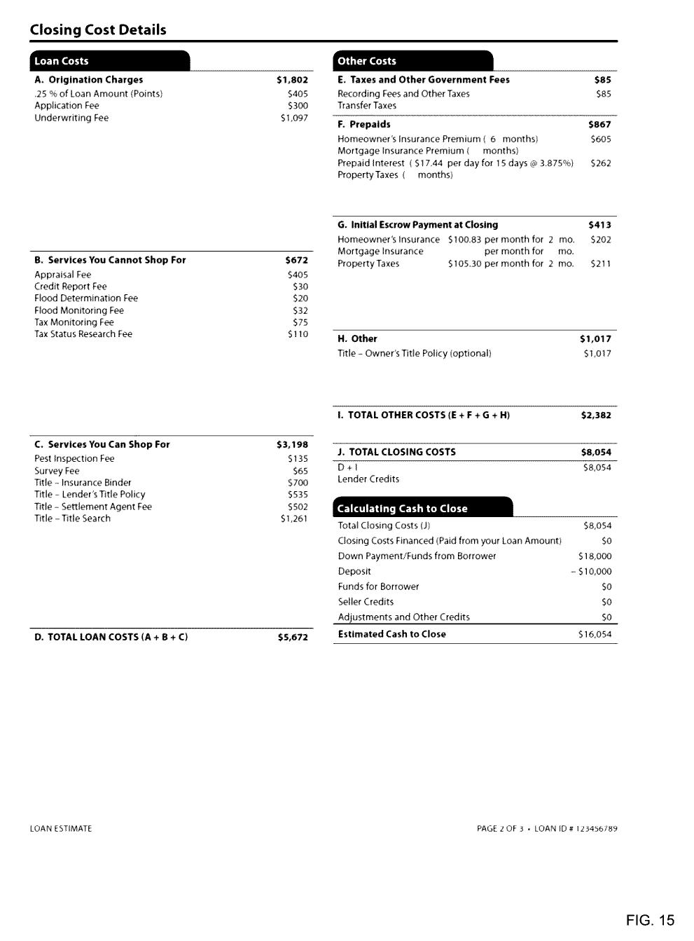

FIG. 16 is a sample page three of a Standardized Loan Estimate example.

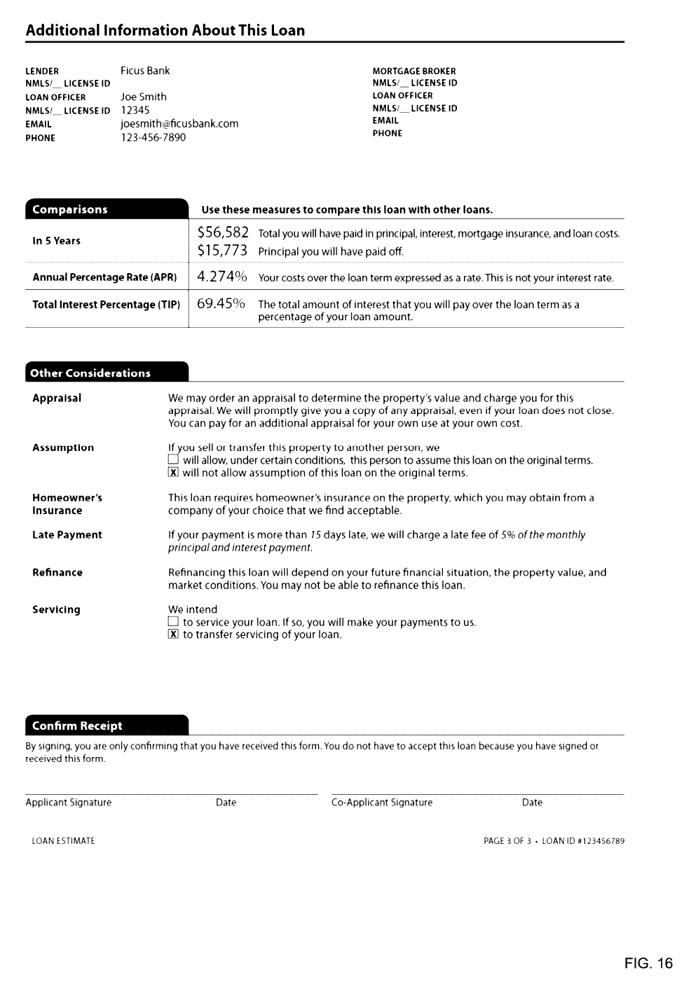

FIG. 17 is a sample portion of a Standard Loan Estimate indicating that an applicant's name is a callout for #2.

FIG. 18 is a sample portion of a Standard Loan Estimate where the calculation of the down payment percentage is calculated for GMR, and the application will derive it via the Down Payment/Funds from Borrower field.

FIG. 19 is a sample portion of a Standard Loan Estimate demonstrating the system and method parsing additional information about the loan, such as, a sample comparison of a given loan with other loans that may be executed.

### DETAILED DESCRIPTION

For clarity of disclosure, and not by way of limitation, the detailed description of the invention is divided into the following subsections that describe or illustrate certain features, embodiments or applications of the present invention.

### Definitions

“Computer system” as used herein means any processing device, including but not limited to mobile and desktop devices, or processing devices that are interconnected and may or may not operate independently, but have the ability to communicate with other external devices and processing devices and capable of configuration with software.

“Report” as used herein means a physical or electronic or orally delivered document containing loan information in a narrative, graphic, or tabular form prepared on an ad-hoc, periodic, recurring, regular, as required or as requested basis.

“Database” as used herein means a repository of indexed information.

“Library” as used herein means a database of indexed information specific to a certain task or software use.

“Costs of a loan” as used herein means all time, money or anything of value that is directly associated with and paid or given up by a consumer in obtaining a loan other than the loan principal amount.

### The System and Method of the Present Invention

In one embodiment, there are 4 payloads persisted to the storage component during the sequence:

The first payload contains the files that were uploaded, and their original file names.

The second payload contains the complete textual and complete XML representations of the uploaded file(s) as extracted and created from the uploaded files via an optical character recognition (OCR) engine and/or optical document recognition (ODR) engine, as well as specific field level information obtained from an uploaded file via an OCR/ODR engine for a predefined set of fields that the user may be asked validate.

The third payload contains the field level information that the user accepted on the validation screen.

The fourth payload contains a data-interchange request to a so-named ‘Get My Rate’ module, and a data-interchange request response that contains the most desirable debt instrument(s) returned.

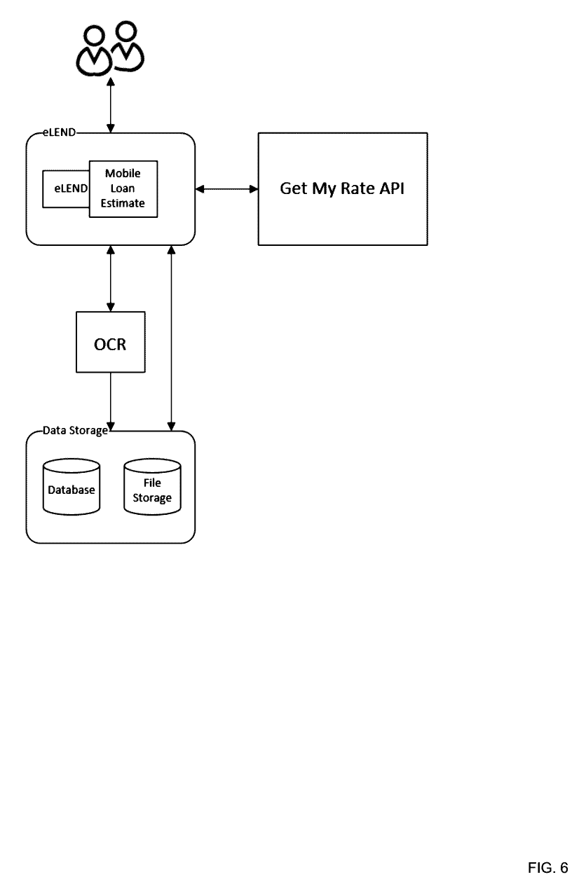

Referring to FIG. 6, in one embodiment, the web pages and middle tier required to solicit a Standard Loan Estimate from a user will be an extension built on top of an existing lending institution product, implemented as additional pages using the same technologies, practices and infrastructure that are currently in place at a given time from that lending institution or alternatively, through a web portal of a third party website where there exists a click through portal to said extension.

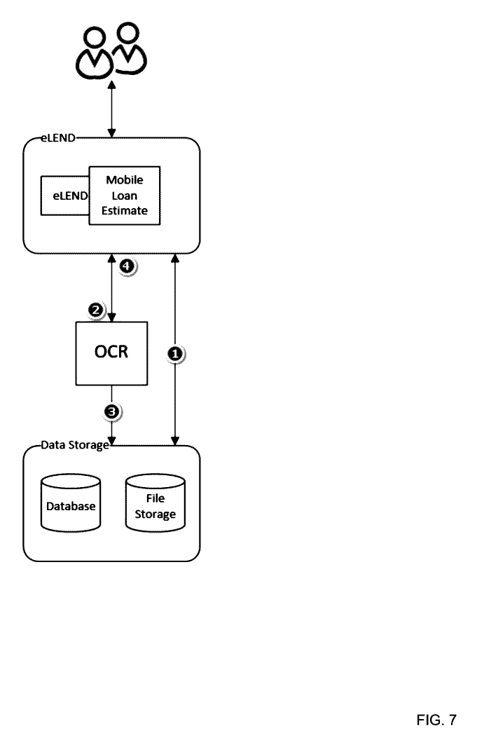

Referring to FIG. 7, in one embodiment, the Mobile Loan Estimate module will upload the user submitted PDF or image files to data storage (1), and then pass the file path(s) of the uploaded PDF or images to an OCR library from any suitable third party OCR/ODR software vendor (the “OCR Engine”) (2). One such OCR Engine is marketed under the brand name ABBYY®. A library will reside on a dedicated server, and an enclosing REST API interface will let the application call the OCR Engine (2) remotely. If and when a lending institution wishes to parse another document type (for example, a W2 or property tax bill) in the future, then the lending institution can use the OCR Engine's exposed web service at its disposal, separated from Loan Estimate recognition work. The OCR Engine will process any text from the files, and persist the text and XML to the database (3), before returning the result to Mobile Loan Estimate (4). The uploaded PDF or image files will reside and persist for a set period of time in data storage (1).

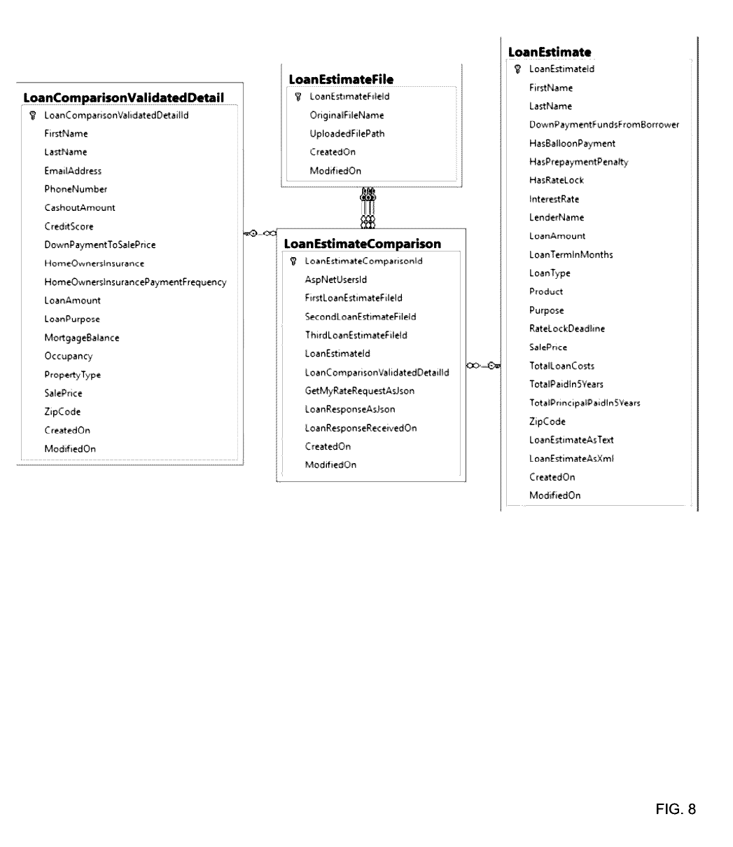

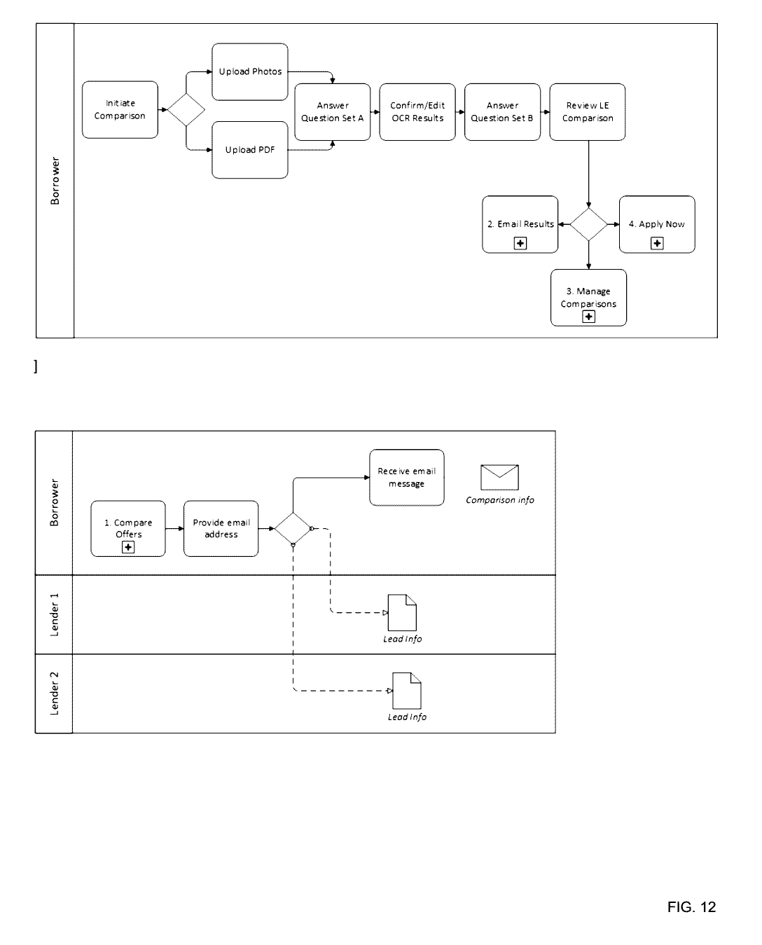

Referring back to FIG. 6, in one embodiment, with the information parsed from the Standard Loan Estimate, and with information solicited from the user as disclosed on FIGS. 8, 11 and 12, the Mobile Loan Estimate module will call the Get My Rate API to get a list of comparable debt instruments offered by a lending institution. The call to Get My Rate will be encapsulated within the C# middle tier of Mobile Loan Estimate module. The Mobile Loan Estimate module will filter this list to offer the user an apples-to-apples comparison between the product in their Standard Loan Estimate and the most similar and most competitive similar debt instrument product, or alternatively, any requested debt instrument product by the consumer. The system administrator will supply updated algorithms to rank loan products or loan features from time to time as variables get updated.

In one embodiment, for redundancy, the OCR Engine is placed on 2 load balanced servers, with its licenses installed on each of those servers when in production. For all non-production environments, the OCR Engine may be placed on 1 server. Other components like the database or the proprietary software web app will be deployed according to existing procedures.

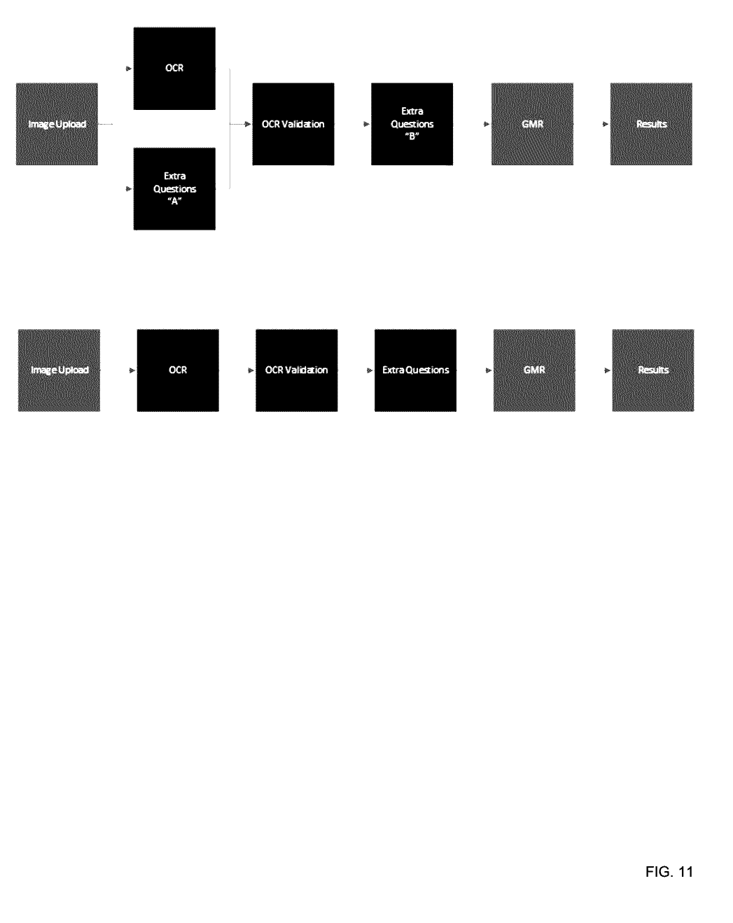

In one embodiment, a consumer may initiate the system and method as disclosed herein after obtaining a Standardized Loan Estimate and calling the system and method into action via a mobile application, through a direct website or through a portal click through of a third party website. Upon such initiation, which may be performed by clicking an icon, mouseover, sending an audible signal, and the like, the system may prompt the consumer to upload a Standardized Loan Estimate. Uploading may be accomplished via scanning, directing the Standardized Loan Estimate toward a camera, directly sending an electronic file, and the like. In one embodiment, at that point, the system and method perform its actions as detailed herein and may begin OCR activity and then prompt the user to validate information through a series of questions. Alternatively, the user validation questions may be broken into groups and some posed to the consumer during the OCR activity phase. For example, referring to FIG. 11, two alternative potential workflows are depicted.

Thus, in one embodiment, such questions as “what type of property is this?”; “how will you use this property?”; “what is your credit score?”; and “how might we contact you?” are unrelated to the information on the uploaded document and can be asked, if needed, during OCR activity. Such questions as, “what is the current balance on your existing mortgage loan?” and “what is your legal name?” depend on information from the uploaded document and are asked after the completion of the OCR activity.

In one embodiment, after the consumer uploads a document, a confirmation message is sent informing the consumer a successful upload is complete. Then OCR processing is initiated. Once the OCR process is complete, a confirmation message may be sent to the consumer that the loan estimate was successfully read.

In one embodiment, a report will be generated for the consumer comparing the loan in the uploaded Standardized Loan Estimate with loans available from other chosen lenders and may include such information as the loan costs in five years, the principal to be repaid in five years, the annual percentage rate, among others, enabling the consumer to see the various important loan variables on a side by side basis for available loans in real time. In one embodiment, the consumer may be provided with a link to have the report emailed, or a link directly to the alternative lender to apply for a desired loan or a link directly to a lender to generate a closing package based on an already approved loan. In the case where only a Standardized Loan Estimate is at issue and an actual application is still needed, as the report is generated and provided to the consumer, a corresponding report is generated about the consumer and provided to the lender whose loan information was requested by the consumer.

In one embodiment, the consumer may want to consider the various loan instruments available and not want to take any action at that moment. In such a case, the consumer may create an account to store these current comparison reports and retrieve at any given time and compare to future reports.

In one embodiment, uploading documents may include such documents as the consumer's most two recent year's tax returns, W-2 paystub information, bank statements, credit card statements, other debt instrument information and other information typically required for a lending institution to approve or deny a particular loan application. In an additional embodiment, such documents may include an executed form permitting the system to directly obtain updated consumer financial documents as they are updated from time to time. In this manner, the system and method may maintain an up to date financial profile for the consumer at any given point in time.

In one embodiment, lenders must create a lender account and maintain a database of all of their current rates, loan requirements, overlays, costs and fees associated with a given loan instrument and the credit picture of a consumer who is eligible for such loan.

In one embodiment, before a lender knows the existence of a consumer desiring a debt instrument and before a consumer desiring a debt instrument knows of a lender with a suitable debt instrument that would satisfy the consumer, the system and method can store and retrieve the information necessary to match up that consumer and that lender and generate an alert to each of the other's existence.

In one embodiment, even where there is no consumer actively desiring a loan instrument, but one that nevertheless is using one or more debt instruments, the system and method can store and retrieve information necessary to generate a report for that consumer that there exists one or more debt instruments that, if they replaced the current set of debt instrument(s) of that consumer, the fiscal picture for that consumer would be improved over a certain time frame that is disclosed to the consumer for the consumer to consider and choose if the consumer believes that the savings over the time frame justifies the switch.

### EXAMPLES

The present invention is further illustrated, but not limited by, the following examples.

In one embodiment, the requirements of the Mobile Loan Estimate application, an enhancement to a proprietary software application, allows users to compare loan estimates from other lenders with a lending institution's most competitive offers. The proprietary software application is a web based application where users can receive a mortgage quote online or a mobile device application.

With the introduction of legislation to standardize the presentation of mortgage terms and conditions to borrowers, the proprietary software application is extended with a Mobile Loan Estimate module to parse information from a user's Standardized Loan Estimate issued by a different lending institution, to determine whether a lending institution can issue a debt instrument on more favorable terms. The Mobile Loan Estimate module allows a user to upload either a PDF which the Standard Loan Estimate, or 3 images files of the Standard Loan Estimate pages.

In one embodiment, a user's flow through the application begins with their arrival a

Compare Estimates screen of the Mobile Loan Estimate module (or similar screen of a web based application or that of a third party website). From here the user would choose to upload either a PDF or image file (photograph) of a Standard Loan Estimate they received from a first lender (or alternatively, any loan estimate or debt instrument proposal).

In regards to a user who uploads a PDF of their Standard Loan Estimate, in one embodiment, the system and method disclosed herein will perform OCR on the text of the Standard Loan Estimate via the OCR Engine and present the predetermined parsed information to the user so the user can confirm the information, or modify it in the event that the OCR Engine incorrectly read any particular field of the Standard Loan Estimate. In one embodiment, during the OCR activity, the system and method may pose questions unrelated to the information on the Standardized Loan Estimate.

The PDF is usually expected to be a 3 page Standard Loan Estimate, however in some cases lenders may give the users a Standard Loan Estimate embedded in a packet of information. In this scenario the users can upload to the Mobile Loan Estimate module a PDF of the entire packet with a Standard Loan Estimate contained therein. In this case, the system and method disclosed herein will perform OCR on the entire packet via the OCR Engine to find and parse information from the Standard Loan Estimate.

Next, the Mobile Loan Estimate module will prompt a user for additional information which does not appear on the Standard Loan Estimate. These questions will be presented with a standardized proprietary software application wizard format.

At this point, the system and method disclosed herein, through the Mobile Loan Estimate module, will have all the information it needs to offer a user a lending institution's rate for a comparable debt instrument. Regardless of the lending institution's rate compared to the Standard Loan Estimate , the result will be displayed via the Mobile Loan Estimate module with an offer to apply and/or, in one embodiment where already approved, to accept.

In one embodiment, if a PDF file is unavailable, a user can upload an image/photograph via the Mobile Loan Estimate module. Photographs may be in the following format: .png, .jpeg, .gif or any other common image file type. A user will be shown a confirmation when their photos have been uploaded. Users may upload up to 3 photographs, 1 per page, of their Standard Loan Estimate. Unlike the PDF process, if a lender provides a user with a packet of information and the user wishes to upload images, then Mobile Loan Estimate module expects the user to only photograph and upload the 3 pages of the Standard Loan Estimate. After the photos/images have been uploaded successfully, the users will have a chance to modify the recognized values, parsed from the Standard Loan Estimate via the OCR Engine, on the validation screen. Such validation screen is identical to the one when users upload a PDF. The remainder of the flow will proceed identically as if a user uploaded a PDF.

In one embodiment, errors are handled in connection with file uploads. For example, for each action of file uploads, the OCR Engine and the GetMyRate Module (“GMR”) may account for 3 errors (upload fail, OCR fail, etc). For the first two retries, specific error messages will be displayed with an action to retry. For the “third strike” error, an alternate error message will be displayed with a lending institution phone number, with no further action available. In an alternate embodiment, the system will not output a ‘third strike’ error and instead will read in the data that it can and prompt the user for the missing items and/or to correct and/or check the read in data to insure accuracy.

In one embodiment, in order to return a specific lending institution's rates to a user, the system and method disclosed herein may rely on a third party web service that will accept parameters who use GMR input. The application then will also parse other parameters for output filtering and displaying results, for example, according to the following table:

| Parameter | Use | Callout |
|---|---|---|
| Date Issued | Results Page | |
| First Name | GMR Input | 2 |
| Last Name | GMR Input | 2 |
| Zip Code | GMR Input | 4 |
| Sale Price | GMR Input | 5 |
| Loan Term | GMR Output Filter | 6 |
| Purpose | GMR Input | 7 |
| Product | GMR Output Filter | 8 |
| Loan Type | GMR Output Filter | 9 |
| Rate Lock | GMR Output Filter | 11 |
| Rate Lock Dead Line (in Days) | GMR Output Filter | 11 |
| Loan Amount | GMR Input | 13 |
| Interest Rate | GMR Output Filter | 15 |
| Prepayment Penalty | Results Page | 19 |
| Balloon Payment | Results Page | 20 |
| Total Loan Costs | Results Page | 59 |
| Lender Credits | Results Page | 85 |
| Down Payment/Funds from Borrower | GMR Input | 89 |
| In 5 Years Total | Results Page | 108 |
| In 5 Years Principal | Results Page | 109 |
| Annual Percentage Rate | Results Page | 110 |
| Total Interest Percentage | Results Page | 111 |

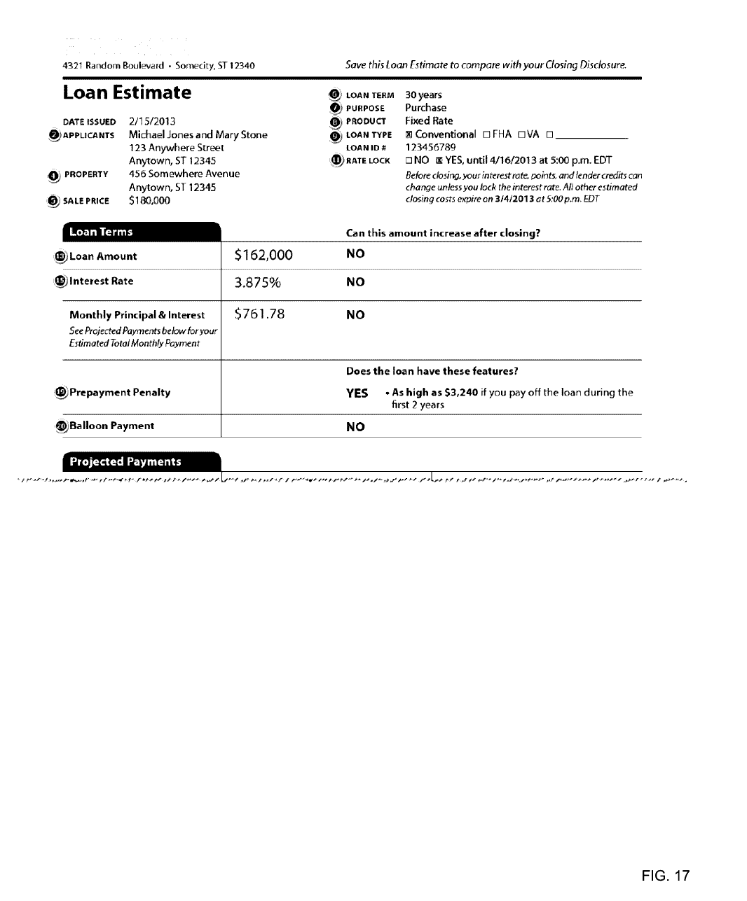

In one embodiment, the system and method disclosed herein may then retrieve the data for each parameter by finding the parameter's callout number overlaid on the Standard Loan estimate. For example, according to the preceding table, the First Name, callout number 2, can be found beside the callout for #2 in a corresponding Standard Loan Estimate. For example, referring to FIG. 17, a portion of a Standard Loan Estimate is reproduced indicating where an applicant's name is, a callout for #2.

In one embodiment, if the Standard Loan Estimate was issued more than 8 days ago, the

Mobile Loan Estimate module will display messaging to the user indicating to them of that fact. The first name may be parsed by removing common salutations and punctuation from the beginning of the name, and accepting the first alphabetic character until the first space found thereafter. The last name may be taken from the string that remains, beginning with the first alphabetic character. The zip code may be the first 5 numeric characters that follow the last space in the address string. The rate lock may be represented as a Boolean field, and a separate field will capture days remaining until the rate lock deadline. The days remaining until the deadline may be 0 when the date of the rate lock is the same as the date of the OCR. Otherwise, the days remaining may be computed if the deadline is in the future relative to the time the information is displayed to the user. When computed, the days remaining may be rounded to the smallest integer greater than fractional number of days remaining.

In one embodiment, in another example, if the system and method disclosed herein parses the above document on Apr. 15, 2013 5:01 P EDT, then the fractional number of days remaining is approximately 0.99. The days remaining field will be 1. If the fractional number of days remaining is 1.4, then the days remaining is 2. If the ratelock ends in less than 8 days, a message will be displayed; the message may say “X days remaining” if <8 days and greater than 0 and will say “ends today” if =0.

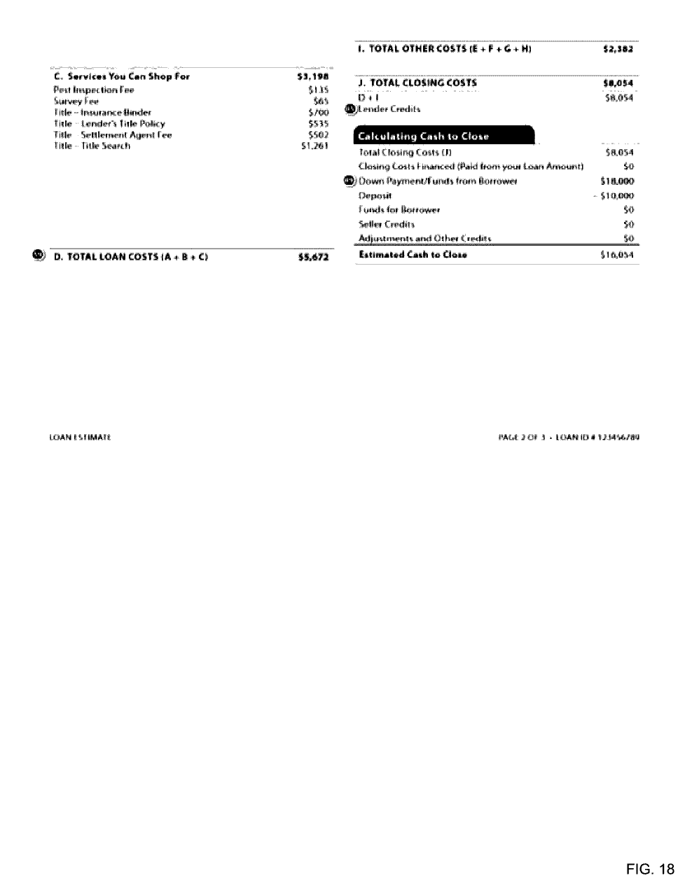

In one embodiment, the down payment percentage needs to be calculated for GMR, and the application will derive it via the Down Payment/Funds from Borrower field. For example, refer to FIG. 18 for an example of such calculation.

In the embodiment of the prior example, the calculation may be:

The Down Payment/Funds from Borrower will be represented as a percent computed as:

$$\frac{Down Payment \text{\textbackslash} Funds from Borrower}{Sale Price}$$

For example, in this Loan Estimate the value is: 0.10=18,000/180,000. The fields in the Comparisons section may be used in the Results screen to determine if the lending institution can present a better offer to the user.

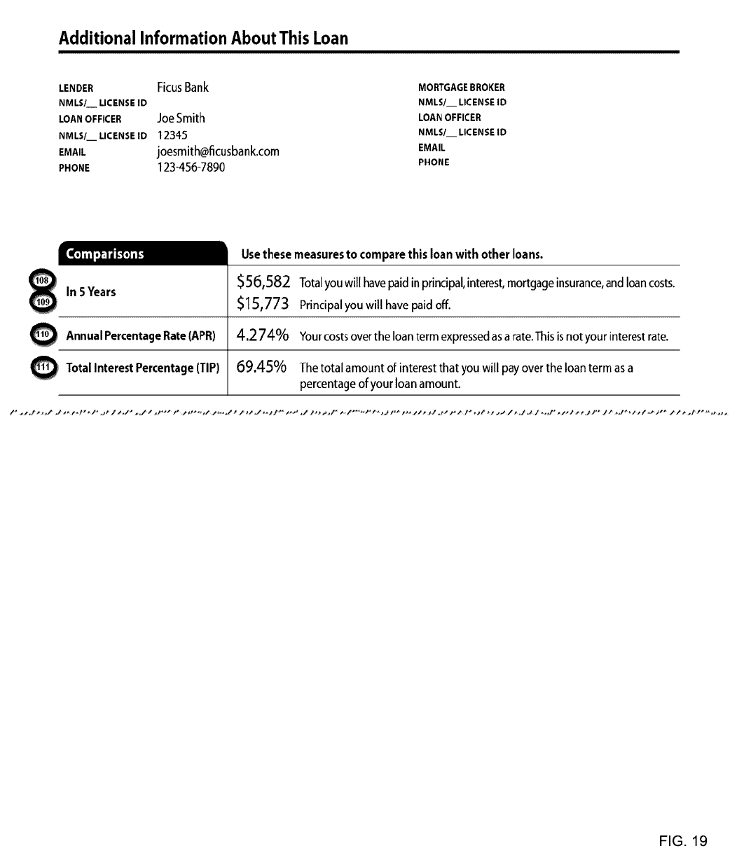

In one embodiment, the system and method disclosed herein may parse additional information about the loan. For example, refer to FIG. 19 to see a sample comparison of a given loan with other loans that may be executed.

In one embodiment, the system and method disclosed herein may also pass an email address and credit score that will be solicited by the questions form, and are not on the Loan Estimate.

In one embodiment, system and method disclosed herein may also use parameters that will be hardcoded to a constant value of 1 and passed to the Get My Rate API, such as taxes, payment frequency for taxes, insurance and payment frequency for insurance.

In one embodiment, the system and method disclosed herein may also be configured to determine the terms of a particular lending institution's offer by passing the following fields to the Get My Rate module:

In one embodiment, the information returned by the Get My Rate module may be filtered and ordered according to an algorithm provided by the lending institution.

In one embodiment, the filtering will compare fields from Get My Rate module and the Loan estimate form, such as:

1. GMR terminMonths=LE Loan Term
a. Divide GMR value by 12 to get number of years for LE

2. GMR isARM=LE Product
a. GMR True=LE Adjustable Rate
b. GMR False=LE Fixed Rate

3. GMR ProduetType=LE Loan Type
a. GMR Conforming=LE Conventional
b. GMR NonConforming=LE Conventional
c. GMR FHA=LE FHA
d. GPM VA=LE VA
e. GMR Rural=LE “other”
   and according to the following table:

In one embodiment, the Mobile Loan Estimate module is configured to display fields in a side by side comparison, such as, In Five Years Total; In Five Years Principal; Annual Percentage Rate; Total Interest Percentage; Total Costs Minus Lender Credits. Initially, a simple numerical comparison of the number of winning fields may be used to determine the overall winner, However, a more sophisticated model may be configured to account for a weighted algorithm to the extent some fields are more important than others in a given situation.

In one embodiment, the OCR Engine may store the original uploaded PDF or images. A rolling store of data, for example, potentially 600 GB of the most recent data may be saved in a database, including any XML metadata or other data that may be recorded as part of the scan. In one embodiment, a user may initiate an account such that a specific database for that user is created in which to store that user's specific data.

In one embodiment, a hardware requirement for the described solution includes, 2 load balanced servers to host the OCR Engine in production redundantly. Each server may have at least, a license locally installed, 5 GB of hard disk space, 1.5 GB RAM and a 1.5 Ghz processor; 1 server to host OCR Engine in all non-production environments; and 1 server for storage of uploaded files. Mobile Loan Estimate may not store files on the server on which it resides.

In one embodiment, the foregoing example may be limited by the ability of the OCR Engine which may be impacted by: how much or whether the paper is crumpled or torn; how dimly or whether the paper is lit; whether the text is in the frame of the photo; the quality of the printer printing the document; the quality of the camera photographing the document; the quality of the scanner scanning the document; other factors affecting the legibility of the document.

It should be appreciated that the foregoing techniques may be implemented with any debt instrument and is not limited to mortgage loans. In one embodiment, a user may have an account where certain information is entered and verified once and/or updated and verified with a required frequency such that the system and method described herein already ‘knows’ the user. Thereafter, any overlays of a particular loan are read in context and viable debt instruments of a particular lending institution are known and pre-approved according to the known parameters and the newly entered parameters.

In one embodiment, by a user having an account and a set of known information, the system and method can generate available debt instruments and the conditions upon which the user may accept them at any given point in time without any need for the user to apply or have a new credit check.

In one embodiment, the system and method disclosed continuously monitors the user's active debt instruments and total fiscal income and outflow obligations and compares them to alternative available debt instruments and generates an alert if an alternative debt scenario is available that would place the user in a better fiscal position relative to the current known obligations.

In one embodiment, a user provides account specific information regarding his/her own fiscal situation (joint debtors may set up a joint account), such as providing the most recent two year's tax returns, W-2 pay stub information or the equivalent, credit card statements, bank statements, credit report and the like. Typically, the user would be prompted to provide the most recent copies of all information that any of the lenders signed into the system with an account would require to offer any of their available debt instruments. Additionally, the user would provide executed permissions for the system and method to obtain updated statements and documents at predefined intervals when updated documents would be available. In this manner, the system and method would always have the user's most current information and snapshot available without a hard inquiry generated and without a ‘user provided’ credit report and other documents.

In one embodiment, the system and method generates a report regarding the user's overall fiscal situation that can be obtained by the user at any point in time and it will be updated and current at that moment.

In one embodiment, there will be lenders who have created lender accounts in the system and have provided information regarding available debt instruments, rates, costs, etc. The lender shall be responsible for continuously updating their rates and costs as to available debt instruments and the criteria for acceptance, or alternatively, allow an integration of the system and method directly into lender's systems such that debt instrument offerings and acceptances come directly through lender's systems through a system and method portal.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

Each and every feature described herein, and each and every combination of two or more of such features, is included within the scope of the present invention provided that the features included in such a combination are not mutually exclusive.

What is claimed is:

1. A report generating system comprising:
a computer system with software configured to receive an upload of a first Standardized Loan Estimate obtained by a consumer from a first lender;
said software further configured to parse data contained on the first Standardized Loan Estimate and isolate and store said data into databases;
said software further configured to store data of a second lender to be used in generation of Standardized Loan Estimates based upon criteria provided by said second lender and the consumer;
said software further configured to compare said isolated and stored data from said first Standardized Loan Estimate with the stored data of said second lender and generate a report evaluating the costs of the loan if closed with either said first lender and said second lender;
said software further configured to store all consumer specific stored data and generated reports into a user specific database for a predetermined amount of time; and
said software further configured to generate a Standardized Loan Estimate of said second lender upon receiving instructions from the consumer of said first Standardized Loan Estimate that they desire the second lender Standardized Loan Estimate.

2. The report generating system of claim 1, wherein said software is further configured to store data of any number of additional lenders to be used in generation of Standardized Loan Estimates based upon criteria provided by consumers and compare said isolated and stored data from said first Standardized Loan Estimate with the stored data of said individual additional lender and generate a report evaluating the costs of the loan if closed with either said first lender and said individual additional lender and repeat the process for any number of individual additional lenders and store all consumer specific data and generated reports into a user specific database for a predetermined amount of time and generate a Standardized Loan Estimate of said any additional individual additional lender upon receiving instructions from the consumer of said first Standardized Loan Estimate that they desire the specific individual lender Standardized Loan Estimate.

3. The report generating system of claim 1, wherein said software is further configured to enable a consumer portal through a third party website to be integrated wherein said third party website alerts consumers that said report generating system of claim 1 is available for immediate use through said portal by initiating said system and uploading a first Standardized Loan Estimate obtained by a consumer from a first lender.

4. The report generating system of claim 3, wherein said software is further configured to notify said second lender upon receiving instructions from the consumer of said first Standardized Loan Estimate that they desire the second lender Standardized Loan Estimate and further configured to permit said second lender to provide said second lender Standardized Loan Estimate directly to said consumer and further configured to store data tracking the consumer's request for and second lender's delivery of second lender Standardized Loan Estimate.

5. The report generating system of claim 4, wherein said software is further configured to notify any number of additional lenders upon receiving instructions from the consumer of said first Standardized Loan Estimate that they desire the individual additional lender Standardized Loan Estimate and further configured to permit said individual additional lender to provide said individual additional lender Standardized Loan Estimate directly to said consumer and further configured to store data tracking the consumer's request for and said individual additional lender's delivery of said individual additional lender's Standardized Loan Estimate.

6. A Standardized Loan Estimate generating system comprising:
a computer system with software configured to receive an upload of a first Standardized Loan Estimate obtained by a consumer from a first lender;
said software further configured to parse data contained on the first Standardized Loan Estimate and isolate and store said data into databases;
said software further configured to permit consumer to choose alternative lenders from a predefined list from whom they desire a Standardized Loan Estimate for the same loan that pertains to the first Standardized Loan Estimate;
said software further configured to permit a chosen alternative lender to view sufficient data from the first Standardized Loan Estimate to generate their Standardized Loan Estimate in connection with the same loan that pertains to the first Standardized Loan Estimate;
said software further configured to permit said alternative lender to generate an alternative Standardized Loan Estimate of said alternative lender upon receiving instructions from the consumer of said first Standardized Loan Estimate that they desire the alternative lender Standardized Loan Estimate and provide said alternative Standardized Loan Estimate to consumer;
said software further configured to store all consumer specific stored data and generated reports into a user specific database for a predetermined amount of time; and
said software further configured to store data tracking the consumer's request for and said individual alternative lender's delivery of said individual alternative lender's Standardized Loan Estimate.

7. A report and optimal debt instrument package generating system comprising;
a computer system with software configured to receive data from a consumer comprising said consumer's credit report, most recent tax returns, existing extended credit card and loan histories and any other documents a pre-registered lender requires for approving an available debt instrument and signed verified permissions to obtain updates of any of the foregoing;
said software further configured to continually monitor said consumer's credit score, debt load structure and overall fiscal situation in real time and use said signed verified permissions to obtain updated consumer data at predefined intervals;
said software further configured to store data from lenders comprising data regarding debt instruments then currently available to consumers with predefined credit scores and debt to income ratios;
said software further configured to analyze said consumer's minimum monthly debt obligations based on the then current debt load structure and project likely repayment scenarios based on projected consumer income;
said software further configured to analyze available debt instruments that could potentially replace the then currently utilized debt instruments and compare said consumer's potential minimum monthly debt obligations and projected likely repayment scenarios based on projected consumer income and utilization of said available debt instruments if used to replace the then currently utilized debt instruments;
said software further configured to compare various debt instrument configurations to determine the lowest monthly cost and the lowest overall repayment cost over a predefined term and generate a report detailing various suggested available approved debt instrument packages and upfront costs to accept;
said software further configured to provide said consumer a report detailing said consumer's current fiscal situation and said consumer's potential fiscal situation if said consumer were to choose to accept available debt instrument replacements to restructure said consumer's fiscal situation.

8. The report and optimal debt instrument package generating system of claim 7, wherein said software is further configured to provide said consumer the option to accept any one of the various suggested available approved debt instrument packages and generate any required closing documents for execution.

9. The report and optimal debt instrument package generating system of claim 7, wherein said software is further configured to generate an alert to a pre-registered consumer desiring a debt instrument of a lender with suitable debt instruments according to pre-defined criteria that are available to and approved for said consumer.

10. The report and optimal debt instrument package generating system of claim 7, wherein said software is further configured to generate an alert to a pre-registered lender offering debt instruments of a consumer desiring one or more debt instruments that are within the offerings of said lender and for which said consumer is approved.
